(19) United States
(12) Patent Application Publication
(10) Pub. No.: US 2026/0203103 A1
(43) Pub. Date: Jul. 16, 2026

(54) MIXTURE OF EXPERT LARGE LANGUAGE MODELS BY USING RESTRICTED SET OF EXPERTS

(71) Applicant: NVIDIA Corporation, Santa Clara, CA (US)

(72) Inventors: Anish Saxena, Atlanta, GA (US); Po-An Tsai, Somerville, MA (US); Bingyao Li, Pittsburgh, PA (US); Aamer Jaleel, Northborough, MA (US)

(21) Appl. No.: 19/023,796

(22) Filed: Jan. 16, 2025

(51) Int. Cl. G06F 9/48; G06F 9/50

(52) U.S. Cl. CPC G06F 9/4881; G06F 9/5016

(57) ABSTRACT

Systems and methods are disclosed that process a pool of incoming requests using a mixture of expert large language model (MOE-LLM). For instance, the pool of incoming requests may be sorted into a plurality of groups of requests based on using a scheduler that selects one or more subsets of a plurality of feedforward layers (FFNs) from the MOE-LLM to service the plurality of groups of requests. The first subset of the plurality of FFNs are loaded into memory of the GPU based on a first group of requests. The first group of requests are serviced using the first subset of the plurality of FFNs to generate responses. While servicing the first group of requests, a second subset of the plurality of FFNs are loaded into the memory of the GPU based on a second group of requests that are to be serviced after the first group of requests.

### BACKGROUND

Mixture of expert (MOE) large language models (LLMs) provide higher quality (e.g., more accurate) results than classic (dense) LLMs of comparable model floating-point operations per second (FLOPS) per token. In MOE-LLMs, each feedforward layer is provisioned with many experts, and only one or a few of which (e.g., top “K” number of experts) are consulted for each in-flight token. Capabilities of larger models, such as MOE-LLMs, are useful in complex tasks with long-context dependencies, such as code completion and question answering. Unfortunately, long-context MOE-LLM inference may be inefficient, due to significantly larger model capacity and smaller, yet more numerous grouped general matrix multiplications (GEMMs) for the MOE architecture, which lower attainable batch size, reduce the efficiency of the grouped GEMMs, and ultimately, the utilized graphics processing unit (GPU) compute throughput (e.g., FLOPS). Conventional MOE-LLMs may perform optimization techniques to reduce inefficiencies, but current key-value (KV) cache optimizations do not aid low GPU efficiency in expert feedforward layers, and current expert management techniques fail to scale beyond small batch sizes. For instance, conventional KV-cache management techniques may reduce the time dedicated to attention mechanism for dense models, but might not solve the root cause of inefficiency in MOE-LLMs, which is lower batch size and inefficient grouped GEMMs, and fail to improve MOE throughput appreciably. As such, there is a need for addressing these issues and/or other issues associated with the prior art.

### SUMMARY

Embodiments of the present disclosure relate to improving MOE-LLMs by using a restricted set of experts. For instance, embodiments of the present disclosure may enable the reuse and sharing of experts across different sequences within a batch, which addresses the inefficiencies of MOE-LLMs in long-context tasks. For example, in contrast to conventional systems, such as those described above, based on constraining a set of experts that are used across different sequences within a batch (e.g., for a given layer), the sequences may be forced to share and reuse the limited set of experts, which may improve grouped GEMM operation intensity (OI), their efficiency, and consequently, the utilized GPU compute throughput.

In other words, in some examples, embodiments of the present disclosure describe a process that preserves Quality-of-Service Service Level Objectives (QoS-SLOs) and maximizes compute throughput of the GPUs based on using domain-aware scheduling, pre-selecting domain-specific experts, switching domain experts, and/or offloading inactive experts. For instance, embodiments of the present disclosure may use domain-aware scheduling to schedule incoming requests in a domain-aware manner based on first sorting the requests. Once the domain of incoming requests is known (e.g., based on using the domain-aware scheduling), the relevant experts at each layer of the model are pre-selected to be used. Following, once a pool of requests is exhausted, a next set of domain-specific requests are scheduled and pre-selection of a potentially different set of experts is performed. Additionally, and/or alternatively, the inactive experts may be offloaded from the memory of the GPU. This and other embodiments will be described in further detail below.

In an embodiment, a computer-implemented method for processing a pool of incoming requests using a MOE-LLM is provided. The method comprises sorting, by a computing platform comprising a GPU, the pool of incoming requests into a plurality of groups of requests based on using a scheduler that selects one or more subsets of a plurality of feedforward layers (FFNs) from the MOE-LLM to service the plurality of groups of requests.

The method further comprises loading a first subset of the one or more subsets of the plurality of FFNs of the MOE-LLM into memory of the GPU based on a first group of requests from the plurality of groups of requests and servicing the first group of requests using the first subset of the plurality of FFNs that are loaded into the memory of the GPU to generate responses to the first group of requests. The method also comprises while servicing the first group of requests, loading a second subset of the one or more subsets of the plurality of FFNs into the memory of the GPU based on a second group of requests from the plurality of groups of requests that are to be serviced after the first group of requests.

### BRIEF DESCRIPTION OF THE DRAWINGS

The present systems and methods for improving MOE-LLMs by using a restricted set of experts are described in detail below with reference to the attached drawing figures, wherein:

FIG. 1A illustrates an environment that includes a computing platform for servicing incoming requests using a restricted set of expert MOE-LLMs, in accordance with an embodiment;

FIG. 1B shows an example of an operation of a portion of the trained MOE-LLM of FIG. 1A, in accordance with an embodiment;

FIG. 1C shows an example of an operation of the feedforward layers from a transformer block of the trained MOE-LLM of FIGS. 1A and 1B, in accordance with an embodiment;

FIG. 2 shows an overview for processing incoming requests by a computing platform, in accordance with an embodiment;

FIG. 3 provides a flow diagram illustrating a method for improving MOE-LLMs by using a restricted set of experts, in accordance with an embodiment;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary game streaming system suitable for use in implementing some embodiments of the present disclosure.

### DETAILED DESCRIPTION

Prior to describing embodiments of the present disclosure, long-context LLM serving optimizations, including the shortcomings of using the optimizations in MOE-LLMs, are first discussed. For instance, the decoding phase of LLM inference, which utilizes most of the end-to-end latency, becomes highly memory bound for long-context serving. This may be because the computation time of the attention kernel scales quadratically with context length, as each sequence attends to its previous context independently. Thus, this may result in lower OI of just 2, which is orders of magnitude lower than the compute-intensive “knee” OI of modern GPUs.

The time spent in attention may be reduced by limiting the active context of a sequence. Recent techniques achieve this by selecting a salient subset of the context based on an intermediate tensor in the attention kernel for each in-flight token of a sequence. To maintain accuracy, all context are still stored in GPU memory, but only a subset are used for computation. In long-context LLM serving, as the time dedicated to the attention mechanism reduces, the feedforward layers (e.g., GEMMs) dominate runtime again and experience improved GPU compute throughput as the batch size increases. As such, recent techniques have been shown to improve long-context dense LLM serving throughput for non-MOE models.

Unfortunately, MOE-LLMs still perform poorly even if long-context optimizations are enabled. For example, as MOEs dedicate more model FLOPs to grouped feedforward GEMMs, the time spent in the attention mechanism is smaller, which limits the impact of context management techniques. In addition, the model capacity (e.g., memory footprint) is much larger in MOEs, which severely constrains the maximum batch size and reduces reuse of the weights of the grouped GEMMs. Furthermore, unlike dense models where all tokens in the batch are processed by the same feedforward layer, the gating network in an MOE routes each token to the top “K” number of experts, which results in many smaller GEMMs with lower OI. As a result, MOE models have a much lower utilized GPU compute throughput in long-context serving compared to dense models.

Furthermore, it has been shown that the batch size and consequently, GEMM efficiency, of MOEs may be improved by offloading experts to reduce model footprint. Unfortunately, on-demand expert fetch exposes the slow central processing unit (CPU) to GPU bandwidth, which degrades throughput. Even with accurate prefetching or speculation, the fetch latency of the current experts cannot be fully overlapped with compute, because the LLM serving is memory bound.

Moreover, expert caching techniques that exploit high temporal locality in experts between back-to-back tokens in the same sequence to reduce prefetching overhead do not scale to larger batch sizes, as significantly more experts are typically activated. This results in low expert-cache hit rates. As the probability that all experts may be activated becomes close to 1 (e.g., 100%) at larger batch sizes (e.g., batch sizes greater than sixteen) for MOE models, the capacity benefit (and hence, batch size improvement) of expert caching may become negligible. Further, these techniques do not improve the low efficiency in expert feedforward layers (e.g., grouped GEMMs) at throughput-oriented batch sizes.

The limitations of prior single batch serving techniques are next described. In a limiting example, batch size may be restricted to 1, which may be due to either quality-of-service requirements or interactive inference at the edge. In this example, the dense model throughput may be improved by leveraging a small model to speculatively decode a small set of tokens and then using a large model to verify the output of the small model. Such speculative sampling techniques feed decoded tokens by the small model as a prefill to the large model. Then, the next-token prediction of the large model verifies the output and takes measures in case of incorrect speculation by the small model.

Unfortunately for MOE models, the tokens decoded by the small model may be routed to multiple experts, which may reduce the efficacy of speculative sampling. For example, with a dense LLM, the maximum achievable gain in throughput with a sampling length of three would be 3 times, because three decode stages in the large model may be replaced by 3 times the decode iterations of the small LLM, as well as a one prefill stage of the large model. If the small model is much faster than the large dense model, the speculative path and verification may be approximated to take a time that is similar to one decode stage of the large model, which results in a 3 times gain in throughput. In an MOE model, however, decoding one token may utilize two experts, and with speculation, on average, 4.6 experts may be utilized to process three speculative tokens. In view of this, the maximum achievable gain in throughput is just 14%, which is 2.6× lower than dense models. Therefore, low reuse of expert weights may result in low efficiency gains.

In view of the above and to address the issues of the prior art, systems and methods are disclosed herein that relate to improving MOE-LLMs by using a restricted set of experts. For example, embodiments of the present disclosure enable such reuse and sharing of experts across different sequences within a batch (e.g., for a given layer) based on building on top of a recent training technique. Instead of training a monolithic MOE LLM, the recent training technique pre-trains standalone expert LLMs separately (e.g., on different datasets) and mixes the experts during a fine-tuning phase. As a result, the experts are easily differentiated from each other (e.g., a math-expert, a code-expert, and so on). Moreover, the load balancing objective of the gating network is fine-tuned to retain the domain-specificity of experts. Thus, if sequences within a batch belong to the same (or a small set of) domain(s), only a subset of the experts in each layer may be used, which maximizes expert reuse.

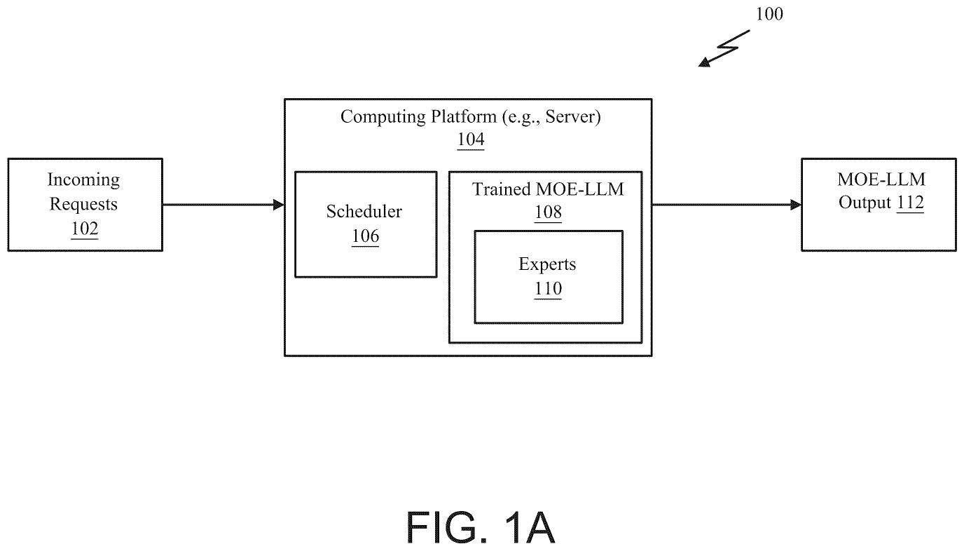

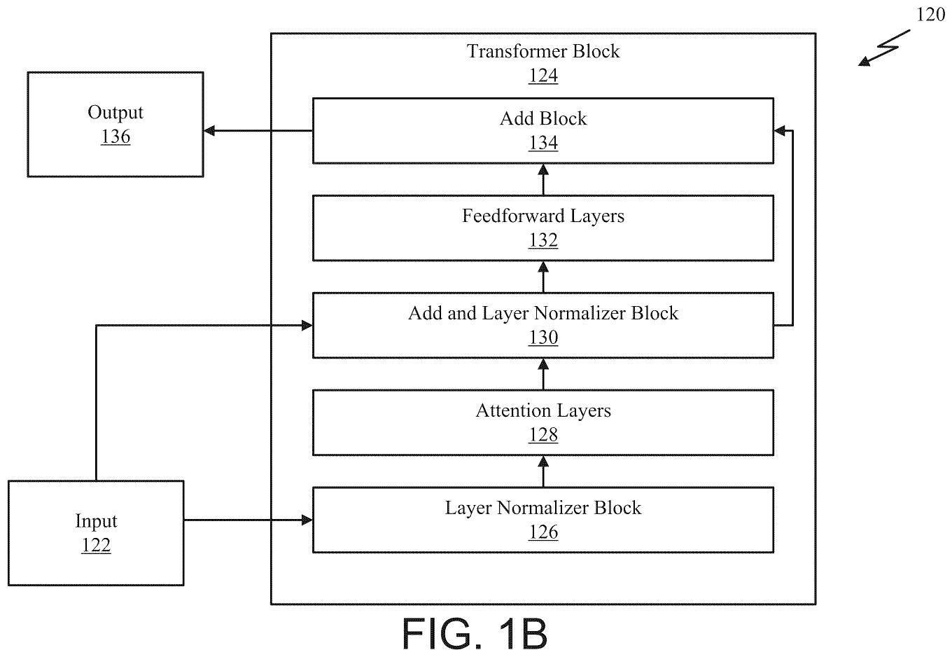

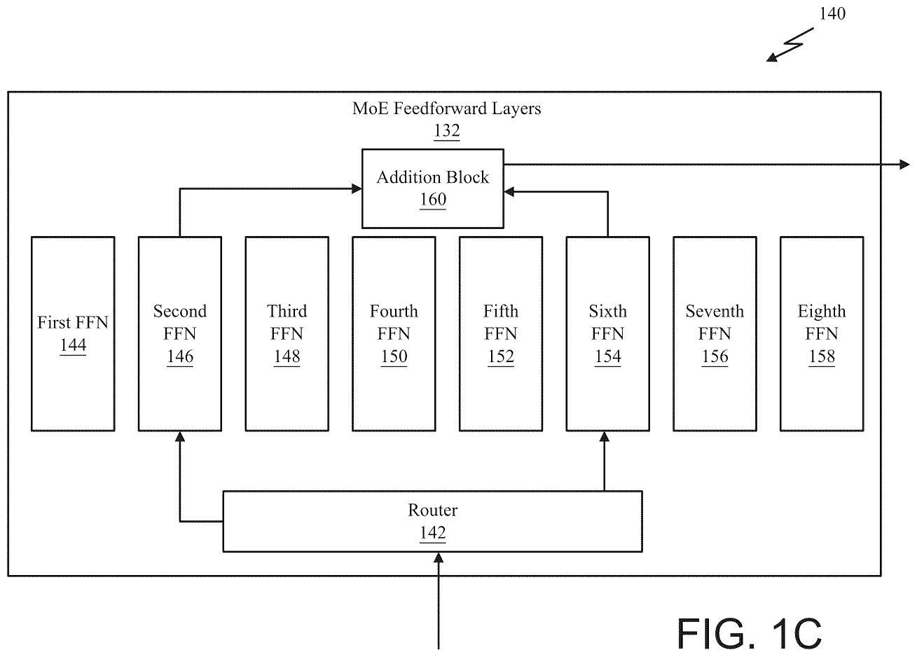

FIG. 1A describes an embodiment of the present disclosure that improves MOE-LLMs by using a restricted set of experts. For example, FIG. 1A illustrates an environment 100 that includes a computing platform 104 for servicing incoming requests 102 using a restricted set of expert MOE-LLMs, in accordance with an embodiment. The environment 100 includes the incoming requests 102, the computing platform (e.g., a server) 104, and an MOE-LLM output 112. The computing platform 104 includes a scheduler 106 and a trained MOE-LLM 108 that includes experts 110. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the computing platform 104 is within the scope and spirit of embodiments of the present disclosure.

In some examples, the computing platform 104 includes one or more computing devices, cloud computing platforms, systems, servers, and/or other apparatuses capable of performing tasks, functions, and/or other actions. In some variations, the computing platform 104 may be implemented as engines, software functions, and/or applications. In other words, the functionalities of the computing platform 104 may be implemented as software instructions stored in storage (e.g., memory) and executed by one or more processors.

For example, in throughput-oriented serving scenarios, a pool of incoming requests 102 (e.g., a pool of requests that belong to different domains) may be available to a serving framework (e.g., the computing platform 104). For instance, the computing platform 104 may include a scheduler 106 and a trained MOE-LLM 108 that includes experts 110 (e.g., MoE feedforward networks (FFNs)). The computing platform 104 may utilize the scheduler 106 and the trained MOE-LLM 108 to service incoming requests 102. For example, a user may provide a request such as a prompt indicating for a specific question to be answered by an LLM. The incoming requests 102 may comprise the request from the user as well as requests from other users and/or entities (e.g., the incoming requests 102 may include one or more batches of requests from a plurality of users and/or entities). The computing platform 104 may process the incoming requests 102 utilizing the scheduler 106 and the trained MOE-LLM 108 to generate MOE-LLM output 112 indicating responses to the requests 102. The MOE-LLM output 112 indicating the responses to the requests 102 may be provided back to the user and/or entities that submitted the requests 102. The operation of the trained MOE-LLM 108, and specifically a transformer block of the trained MOE-LLM 108 is described in further detail in FIG. 1B.

For example, FIG. 1B shows an example of an operation 120 of a portion (e.g., a transformer block 124) of the trained MOE-LLM 108 of FIG. 1A, in accordance with an embodiment. For instance, the computing platform 104 may obtain a trained MOE-LLM 108, and the MOE-LLM 108 may include a plurality of transformer blocks such as the transformer block 124 of FIG. 1B. The transformer block 124 includes a layer normalizer block 126, attention layers 128, an add and layer normalizer block 130, MoE feedforward layers 132, and an add block 134. The operation 120 includes input 122 that is provided to the blocks 126 and 130, and the add block 134 provides an output 136. The MOE-LLM 108 may include any number of transformer blocks such as the transformer block 124. The operation of the MoE feedforward layers 132 from the transformer block 124 is described in further detail in FIG. 1C.

FIG. 1C shows an example of an operation of the MoE feedforward layers 132 from a transformer block 124 of the trained MOE-LLM 108 of FIGS. 1A and 1B, in accordance with an embodiment. For example, the feedforward layers 132 may include a router 142, a plurality of FFNs 144-158, and an addition block 160. FFNs (e.g., the FFNs 144-158) may be feedforward networks or layers. For instance, in contrast to a dense LLM, the MoE feedforward layers 132 may include a plurality of FFNs 144-158 that are specialized for one or more tasks and/or domains. For instance, each of the FFNs 144-158 may be trained utilizing a different data source (e.g., a first data source such as a data source comprising code, a second data source such as a data source from WIKIPEDIA, a third data source such as a data source for mathematical aspects, and so on). By training the FFNs 144-158 using different data sources, the FFNs 144-158 may become specialized to handle specific types or aspects of requests 102. For example, a first request may include code (e.g., software code) whereas a second request may include mathematical aspects. Thus, due to the training using the different data sources, a first subset of FFNs 144-158 (e.g., a first domain) may service the first request better (e.g., provide more accurate responses to the request) and a second subset of FFNs 144-158 (e.g., a second domain) may service the second request better. The router 142 may be trained to select a domain (e.g., a subset of FFNs 144-158) that best handles the requests. For example, as shown, the router 142 selected a domain indicating the second FFN 146 and the sixth FFN 154 to process a request (e.g., the first request). The selected domain (e.g., the second FFN 146 and the sixth FFN 154) may process the input to the MoE feedforward layers 132 to generate two outputs. The addition block 160 may add the two outputs, and the output of the MoE feedforward layers 132 may be a result of the addition.

In some instances, at a high level, the intended usage from the users (e.g. tasks), such as generating software code or summarizing paragraphs, may be observed as a domain. In other words, a domain (e.g., a subset of FFNs 144-158) may be any combination of FFNs 144-158 such as the first FFN 144 and the eighth FFN 158, the second FFN 146 and the sixth FFN 154, the fifth FFN 152 and the seventh FFN 156. In addition, the subsets of FFNs 144-158 may include any number of FFNs. For instance, the above examples of domains include two FFNs (e.g., the second FFN 146 and the sixth FFN 154). In other instances, the subsets of FFNs 144-158 may include other numbers of FFNs such as three FFNs, four FFNs, and so on. While only eight FFNs 144-158 are shown in FIG. 1C, the MoE feedforward layers 132 for a transformer block 124 may include any number of FFNs such as sixteen FFNs, thirty-two FFNs, and so on. In addition, as mentioned above, the trained MOE-LLM 108 may include a plurality of transformer blocks 124, and each transformer block 124 may include a number of FFNs as each transformer block 124 includes MoE feedforward layers 132. The experts 110 of the trained MOE-LLM 108 may be all of the FFNs within the overall trained MOE-LLM 108 (e.g., if each of the feedforward layers 132 include eight FFNs and there are five MoE feedforward layers 132/transformer blocks 124 within the trained MOE-LLM 108, then the trained MOE-LLM 108 would include forty FFNs or forty experts 110). Therefore, a domain may be a subset of FFNs (e.g., a subset of experts) that are from different MoE feedforward layers 132/transformer blocks 124 such as the second FFN and the sixth FFN from a first transformer block 124, a first and fourth FFN from a second transformer block 124, and so on.

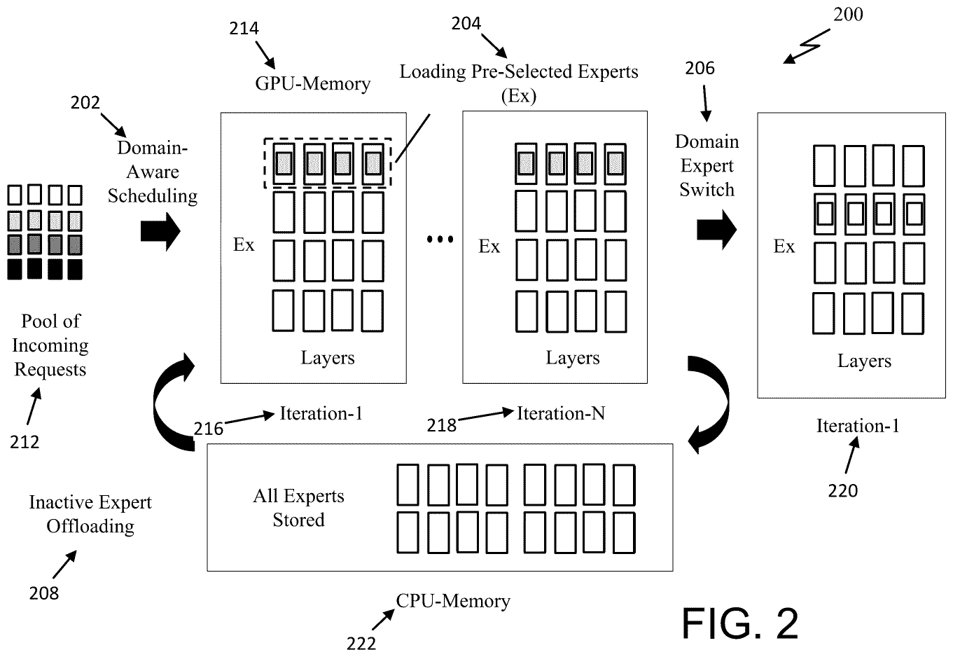

Returning back to FIG. 1A, the computing platform 104 may process the incoming requests 102 initially using a scheduler 106 to group requests that utilize the same domain together. For example, the incoming requests 102 may include sixteen total requests, and using the scheduler 106, the computing platform 104 may group the sixteen total requests into groups of four (e.g., a first group of four requests, a second group of four requests, and so on). Following, the computing platform 104 may perform a hardware efficient process for using the trained MOE-LLM 108 and the experts 110 to process the groups of requests to generate the MOE-LLM output 112. The hardware efficient process is described in FIG. 2.

FIG. 2 shows an overview 200 for processing incoming requests 102 by a computing platform 104, in accordance with an embodiment. For instance, the overview 200 may include a process comprising four steps 202-208. The last step 208 may be optional, and will be described below. In operation, prior to performing steps 202-208, the computing platform 104 may obtain the trained MOE-LLM 108 (e.g., train an MOE-LLM 108, receive the MOE-LLM 108 from another source, and/or load the MOE-LLM 108 from another source) and store the experts 110 of the trained MOE-LLM 108 into memory. The computing platform 104 may include one or more GPUs and one or more central processing units (CPUs), and in some examples, the computing platform 104 may store the experts 110 into the memory of a CPU (e.g., into CPU-memory 222).

Following, the computing platform 104 may obtain a pool of incoming requests 212 (e.g., the incoming requests 102 or a subset of the incoming requests 102), which may belong to different domains (e.g., may be best processed utilizing different subsets of FFNs such as different sets of FFNs 144-158). As such, the objective of the computing platform 104 when performing the process may be to service all requests while preserving QoS-SLOs and maximizing compute throughput of the GPUs. This may be performed using domain-aware scheduling (e.g., step 202), pre-selecting domain-specific experts (e.g., step 204), switching domain experts (e.g., step 206), and/or offloading inactive experts (e.g., step 208).

At step 202, to schedule incoming requests 212 in a domain-aware manner, the computing platform 104 may use the scheduler 106 to first sort the requests 212. The scheduler 106 may be any model (e.g., a separately trained model), classifier (e.g., a domain classifier, heuristics classifier, and/or other types of classifiers), and/or other component that is configured to sort the requests 212 into the domains (e.g., identify a subset of FFNs such as the second and sixth FFNs 146 and 154 to use for servicing/processing a request from the pool of requests 212). For example, in some examples, the scheduler 106 may perform cosine similarity and/or K-means clustering to group the pool of requests 212 into groups of requests. For instance, as shown, the pool of incoming requests 212 include sixteen requests, and the scheduler 106 may group the sixteen requests into four groups of requests. Each group of requests may be associated with a specific domain (e.g., a subset of FFNs) that the scheduler 106 determines is optimal to service the group of requests (e.g., based on cosine similarity and/or K-means clustering). In other examples, the scheduler 106 may include a model such as a neural network (NN) that is configured to sort the pool of requests 212 into a group of requests. In such examples, the scheduler 106 may train the NN prior to using the NN for sorting the pool of requests 212 into the group of requests during inference. In some instances, the scheduler 106 may be and/or include the routers 142 shown in FIG. 1C. For example, the scheduler 106 may be co-trained with the FFNs 144-158 with the objective to learn the categories of incoming requests 102 that get routed to the same expert. And, after obtaining the scheduler 106, the computing platform 104 may perform further fine-tuning of the routers 142.

Following, using the scheduler 106, the computing platform 104 may queue the domain-specific requests such that: 1) requests belonging to the same domain remain together, and (2) across different domain-specific requests, server-level quality of service and service level objectives are maintained. For instance, the computing platform 104 may queue the domain-specific requests (e.g., the pool of requests 212 that have been sorted into different groups) using a queuing algorithm such as, but not limited to, a learning based queuing algorithm and/or a heuristics based queuing algorithm. The queuing algorithm may be based on complexity and runtime latency requirements. In some embodiments, the queueing algorithm may be and/or include a starvation-prevention queuing algorithm, such as combining age (e.g., wait time) when deciding which domain to schedule next.

After sorting and queuing the pool of requests 212, the computing platform 104 may perform step 204. At step 204, the computing platform 104 may load the pre-selected experts into the memory of the GPU (e.g., GPU-memory 214). For instance, as mentioned above, the computing platform 104 may obtain and store the experts 110 of the trained MOE-LLM 108 into the CPU-memory 222. Then, based on the scheduler 106 performing the sorting and queueing, the computing platform 104 may determine the first group of requests that are at the top of the queue (e.g., first in the queue), and determine the domain associated with the first group of requests. As mentioned above, the domain may indicate a subset of FFNs such as the second and sixth FFNs 146 and 154. The computing platform 104, at step 204, may load the domain (e.g., subset of FFNs) associated with the first group of requests. For instance, the computing platform 104 may copy the subset of FFNs from the CPU-memory 222, and load the copy of the subset of FFNs into the GPU-memory 214. For example, as shown, in the GPU-memory 214 are the layers (e.g., feedforward layers for the transformer blocks 124 of the MOE-LLM 108) and the loaded experts (e.g., the FFNs from each of the feedforward layers). After loading the pre-selected experts, the computing platform 104 may perform a first iteration 216 (Iteration-1) using the loaded FFNs (e.g., the second and sixth FFNs 146 and 154) to generate intermediate outputs (e.g., responses) for the first group of requests. The computing platform 104 may perform a plurality of iterations (e.g., “N” number of iterations), and after performing the last iteration 218 (Iteration-N), may generate an output for the first group of requests. In other words, the computing platform 104 may use the same loaded FFNs within the MoE feedforward layers 132 for a plurality of iterations to generate outputs (e.g., responses) for the first group of requests.

To put it another way, once the domain of the pool of incoming requests 212 is known (e.g., via domain-aware scheduling and step 202), the relevant experts at each layer of the MOE-LLM 108 (e.g., the subset of FFNs) are pre-selected to be used. In some embodiments, the set of domain-specific experts that may serve this request pool 212 may be learned in a fine-tuning phase of training the MOE-LLM 108, such as when the scheduler 106 is also trained. In some examples, the experts may themselves be domain-specific, and the set of experts may be well-defined. Moreover, as this set of experts may be pre-selected, unlike expert caching techniques, an expert “miss” may become impossible, which ensures that only the selected experts are used for serving.

Furthermore, at step 206, the computing platform 104 performs a domain expert switch. For instance, during the performance of step 204, the computing platform 104 may further load a second subset of FFNs (e.g., the first and eighth FFNs 144 and 158) to process the second group of requests. For example, the second group of requests may indicate a second domain that is associated with a second subset of FFNs (e.g., the scheduler 106 may determine that the second subset of FFNs may be able to best process the second group of requests). Thus, during the performance of step 204, the computing platform 104 may load the second subset of FFNs such as by copying the second subset of FFNs from the CPU-memory 222 and loading the copy of the second subset of FFNs into the GPU-memory 214. After completing the iterations using the first subset of FFNs, the computing platform 104 may then utilize the already loaded second subset of FFNs to service/process the second group of requests (e.g., begin the first iteration (Iteration-1) of using the second subset of FFNs). In other words, in an example where the computing platform 104 uses one hundred iterations to service the first group of requests, the computing platform 104 may perform step 206 and load the second subset of FFNs into the GPU-memory 214 while the computing platform 104 is performing the one hundred iterations.

Then, after the one hundred iterations are completed, the computing platform 104 may then perform the first iteration 220 using the second subset of FFNs to service the second group of requests. This may continue and the computing platform 104 may repeat steps 204 and 206 to service the remaining groups of requests 212.

In other words, the pool of domain-specific requests 212 and the MOE-LLM 108 comprising the restricted, pre-selected set of experts may be serviced using one or more frameworks. Especially for long-context tasks, the pool of requests 212 may include multiple batches, and thus may require multiple service iterations (e.g., with same set of experts/the same subset of FFNs). Once this pool of requests 212 and/or a batch from the pool of requests 212 is exhausted, the next set of domain-specific requests may be scheduled, which may utilize another pre-selection of a potentially different set of experts 110 from the trained MOE-LLM 108. A domain expert switch may be used to pre-select another potential set of experts 110 from the trained MOE-LLM 108, and the orchestration latency for the domain expert switch may be hidden from the critical path based on executing the pre-selection mechanism on the CPU, which thereby stages the next-set while the current-set is being executed.

At step 208, the computing platform 104 may perform inactive expert offloading. For instance, as all of the experts 110 (e.g., all of the FFNs from the trained MOE-LLM 108) are stored in the CPU-memory 222, once a group of requests has been serviced, the computing platform 104 may perform inactive expert offloading and discard the inactive experts. For example, referring to the above, after servicing the first group of requests (e.g., performing the one hundred iterations), the computing platform 104 may discard the first subset of FFNs. Similarly, after servicing the second group of requests, the computing platform 104 may discard the second subset of FFNs. This may repeat until all remaining requests from the pool of incoming requests 212 have been serviced.

In other words, in some embodiments, with restricted expert serving, all experts 110 may reside in the GPU-memory 214, due to two reasons: (i) the pool of requests 212 of the same domain may be small, requiring frequent domain-switch, or (ii) the QoS-SLO requirements might necessitate frequent domain switch. Nonetheless, if these requirements are relaxed, the inactive experts 110 may be offloaded to CPU-memory 222 to maximize batch size by reducing model capacity. Unlike expert caching, where a cache miss leads to degraded throughput, as embodiments of the present disclosure pre-select experts from the experts 110 of the MOE-LLM 108, the pre-select experts may be pre-fetched transparently. The number of service iterations to be performed to load the required experts (e.g., the pre-select experts) may depend on the CPU-to-GPU bandwidth compared to the high bandwidth memory (HBM) bandwidth of the GPU. With higher CPU-to-GPU bandwidth architectures, the service iterations may be minimized, which may enable tighter QoS-SLOs.

In some embodiments, instead of storing the experts 110 of the trained MOE-LLM 108 into the CPU-memory 222, the computing platform 104 may store all of the experts 110 into the GPU-memory 214. In such embodiments, step 208 might not be performed as all of the experts 110 are stored into the GPU-memory 214 already and therefore, the computing platform 104 might not perform inactive expert offloading into the CPU-memory 222. In addition, at step 204, the computing platform 104 may load the pre-selected experts by determining the experts based on the domain associated with the group of requests to be next serviced. For instance, the computing platform 104 may select a certain subset of FFNs (e.g., the second and sixth FFNs 146 and 154) that may be next used to service the first group of requests. At step 206, the computing platform 104 may perform a domain expert switch by selecting a next subset of FFNs (e.g., the first and eighth FFNs 144 and 158) to service the second group of requests.

In some embodiments, based on using only GPU-memory 214 to store the experts 110, there might not be any overhead to offload, but there may be less memory to store the KV cache for each request, which may reduce the operation intensity. In other embodiments, based on using CPU-memory 222 to store the experts 110 and moving to the GPU-memory 214 as needed, there may be a potential overhead of moving the expert model weights, but there may be more GPU-memory 214 available such that more requests from the pool of incoming requests 212 may be scheduled at the same time, therefore increasing the operational intensity.

In some embodiments, one or more requests from the pool of requests 212 may further indicate the requested experts from the experts 110 of the MOE-LLM 108 to use to service/process the requests. In some instances, the computing platform 104 may use the scheduler 106 to select a subset of FFNs, and may use only those selected FFNs to service the request regardless of whether the requests indicated one or more requested experts to use. In other instances, the computing platform 104 may use the requested experts. For example, by using solely the subset of FFNs selected by the scheduler 106, performance of the computing platform 104 when servicing the request may increase, but accuracy (e.g., how accurate the response to the request is) may decrease. But, by utilizing the requested experts, the computing platform 104 may increase the accuracy; however, the performance may decrease. Thus, in operation, the computing platform 104 may determine whether to use one or more of the requested experts from the request (e.g., perform an accuracy versus performance trade-off calculation and/or computation algorithm and/or based on user input). Based on the determination to use one or more of the requested experts, at steps 204 and 206, the computing platform 104 may load/pre-load the subset of FFNs determined by the scheduler 106 into the GPU-memory 214 and may further load/pre-load one or more of the requested experts associated with the group of requests (e.g., if a request indicates two requested FFNs 144 and 158, the computing platform 104 may further load one or both of the requested FFNs 144 and 158). The computing platform 104 may then use the subset of FFNs determined by the scheduler 106 as well as the additionally loaded FFNs to service the pool of requests 212.

In some examples, the impact of restricting a set of experts in throughput-oriented serving was examined. For example, the impact of the restricted set serving based on the experts being transparently offloaded to secondary memory (e.g., the CPU-memory 222) with increasing batch size and/or smaller expert sets was examined. With two experts on-device, the batch size improves by two times when compared to the unrestricted set of experts, which results in a higher throughput. Moreover, due to the larger compute-friendly group GEMMs, the throughput at a 16,000 output context length was about 25% higher when compared to the dense model, and 3.4 times higher than a baseline MOE model (e.g., the MIXTRAL model).

In some instances, the impact of the restricted set of experts in single batch serving was examined. For instance, the normalized slowdown of the MIXTRAL model using the restricted set of experts with respect to an LLM for single batch serving was examined. While the performance of the baseline MOE (e.g., the MIXTRAL model) degrades by 3.3 times when compared to the dense model at sampling length of 6, restricting the expert set to two experts retains the same performance as the dense model (e.g., a 3.3 times speed-up over the baseline MOE model). Unlike throughput-oriented serving scenarios where different sequences may belong to the same domain to enable the restricted experts, in single batch serving, consecutive speculative tokens of the same sequence may share the same set of experts. Therefore, based on leveraging the observed temporal locality in expert gating across consecutive tokens, it may be possible to restrict experts even if the MOE model is not trained with a Branch-Train-Mix (BTX) approach. The locality may be enhanced during training time by incorporating the temporal locality benefit into the loss function of the router (e.g., the router 142).

In some instances, KV-cache management techniques may reduce the time dedicated to the attention mechanism for dense models, but might not solve the root cause of the inefficiency in MOEs, which may include lower batch size and inefficient group GEMMs. Thus, they may fail to improve MOE throughput appreciably. Prior expert management solutions may be limited to single or small batch serving scenarios. This is because the probability that all experts are activated becomes close to 100% at larger batch sizes, and either all experts are needed (with performance similar to baseline), or expert cache exhibits frequent expert miss, which exposes the slow CPU-to-GPU bandwidth. As such, they may degrade throughput. Unlike embodiments of the present disclosure, expert management techniques might not scale to large batch serving scenarios and might not leverage domain specificity that may be enabled in experts. Further, for single batch serving scenarios, speculative sampling might not improve MOE throughput because verify-tokens may be spread to multiple experts. As before, this might not solve the root cause of less reuse of expert weights compared to dense feedforward weight. Embodiments of the present disclosure may restricts the experts to resolve these issues, aided by observed expert locality and affinity as different in-flight tokens belong to the same sequence, in this case.

As such, in summary, embodiments of the present disclosure may improve MOE-LLMs using a restricted set of experts, such as improving throughput of the MOE-LLMs. Among other benefits and advantages, embodiments of the present disclosure may perform a process that loads a restricted set of experts 110 (e.g., a first subset of FFNs) into GPU-memory 214 (e.g., copying the first subset of FFNs from CPU-memory 222 or selecting the first subsets of FFNs that are already stored within the GPU-memory 214) based on a first group of requests to be serviced next by the computing platform 104. Further, during servicing of the first group of requests, embodiments of the present disclosure may pre-load another set of experts 110 (e.g., a second subset of FFNs) into GPU-memory 214 based on a second group of requests that are to be serviced after servicing the first group of requests. Embodiments of the present disclosure may also use a scheduler 106 to sort and/or queue a pool of requests 212 into different groups of requests. Each group of requests may indicate a domain (e.g., a subset of FFNs). In addition to determining a subset of FFNs to service a group of requests by the scheduler 106, embodiments of the present disclosure may determine and use one or more additional experts (e.g., additional FFNs) to service the group of requests.

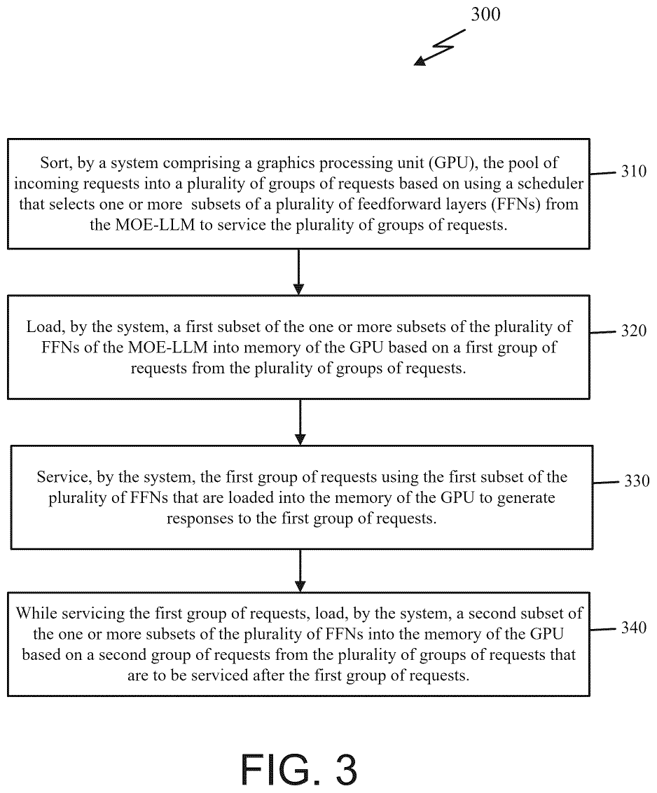

FIG. 3 provides a flow diagram illustrating a method 300 for improving MOE-LLMs by using a restricted set of experts, in accordance with an embodiment. Each block of method 300, described herein, comprises a computing process that may be performed using any combination of hardware, firmware, and/or software. For instance, various functions may be carried out by a processor executing instructions stored in memory. The method 300 may be executed by any one system, or any combination of systems, including, but not limited to, those described herein (e.g., the computing platform 104). Furthermore, persons of ordinary skill in the art will understand that any system that is capable of performing method 300 is within the scope and spirit of embodiments of the present disclosure.

At step 310, a system (e.g., the computing platform 104) that comprises a GPU sorts a pool of incoming requests 212 into a plurality of groups of requests based on using a scheduler 106 that selects one or more subsets of a plurality of feedforward layers (FFNs) from the MOE-LLM 108 to service the plurality of groups of requests. In an embodiment, the sorting the pool of incoming requests comprises sorting a first request from the pool of incoming requests 212 into the first group of requests based on the scheduler 106 indicating that the first request is to be serviced using the first subset of the plurality of FFNs and sorting a second request from the pool of incoming requests 212 into the first group of requests based on the scheduler 106 indicating that the second request is to be also serviced using the first subset of the plurality of FFNs.

In an embodiment, the scheduler 106 indicates that the first request and the second request are to be serviced using the first subset of the plurality of FFNs based on using cosine similarity or K-means clustering. In an embodiment, the scheduler 106 indicates that the first request and the second request are to be serviced using the first subset of the plurality of FFNs based on using a neural network, and the method 300 further comprises training the neural network prior to sorting the pool of incoming requests 212 into the plurality of groups of requests.

At step 320, the system loads a first subset of the one or more subsets of the plurality of FFNs of the MOE-LLM 108 into memory of the GPU (e.g., the GPU-memory 214) based on a first group of requests from the plurality of groups of requests.

At step 330, the system services the first group of requests using the first subset of the plurality of FFNs that are loaded into the memory of the GPU to generate responses to the first group of requests.

At step 340, while servicing the first group of requests, the system loads a second subset of the one or more subsets of the plurality of FFNs into the memory of the GPU based on a second group of requests from the plurality of groups of requests that are to be serviced after the first group of requests. In some examples, step 340 may be optional. For instance, in some embodiments, the method 300 may include step 340. In other embodiments, the method 300 might not include step 340.

In an embodiment, the method 300 further includes receiving the pool of incoming requests 212 from a plurality of user devices and providing the generated responses to the first group of requests to one or more user devices from the plurality of user devices. In an embodiment, the method 300 further includes populating a queue for the plurality of groups of requests using a queuing algorithm, and the queue indicates that the first group of requests is to be serviced prior to the second group of requests being serviced. Further, loading the first subset of the plurality of FFNs and loading the second subset of the plurality of FFNs is based on the queue.

In an embodiment, the method 300 further includes obtaining the MOE-LLM 108, and the system further comprises a CPU. The method 300 also includes storing the plurality of FFNs of the obtained MOE-LLM into memory of the CPU (e.g., the CPU-memory 222). In addition, loading the first subset of the plurality of FFNs into the memory of the GPU comprises loading the first subset of the plurality of FFNs from the memory of the CPU into the memory of the GPU. In an embodiment, loading the first subset of the plurality of FFNs from the memory of the CPU into the memory of the GPU comprises copying the first subset of the plurality of FFNs from the memory of the CPU and loading the copied first subset of the plurality of FFNs into the memory of the GPU. In an embodiment, servicing the first group of requests comprises performing a plurality of iterations of using the first subset of the plurality of FFNs to generate the responses to the first group of requests and the second subset of the plurality of FFNs are loaded into the memory of the GPU while the plurality of iterations is performed using the first subset of the plurality of FFNs. In an embodiment, the method 300 further includes servicing the second group of requests using the second subset of the plurality of FFNs to generate responses to the second group of requests and based on servicing the second group of requests, discarding the first subset of the plurality of FFNs from the memory of the GPU.

In an embodiment, the method 300 further includes obtaining the MOE-LLM 108 and storing the plurality of FFNs of the obtained MOE-LLM 108 into memory of the GPU. The loading the first subset of the plurality of FFNs into the memory of the GPU comprises selecting the first subset of the plurality of FFNs from the memory of the GPU to use for servicing the first group of requests. The loading the second subset of the plurality of FFNs into the memory of the GPU comprises selecting the second subset of the plurality of FFNs from the memory of the GPU to use for servicing the second group of requests.

In an embodiment, the first group of requests indicate one or more additional FFNs to use to service the first group of requests. Further, the first subset of the plurality of FFNs that are loaded into the memory of the GPU to service the first group of requests comprises one or more FFNs that are selected by the scheduler 106 and at least one FFN from the one or more additional FFNs that are indicated by the first group of requests.

In an embodiment, at least one of steps 310-340 are performed on a server or in a data center to processing a pool of incoming requests 212 using an MOE-LLM 108, and responses to the requests are streamed and/or provided to a user device. In an embodiment, at least one of steps 310-340 is performed within a cloud computing environment. In an embodiment, at least one of steps 310-340 is performed for training, testing, or certifying a neural network employed in a machine, robot, or autonomous vehicle. In an embodiment, at least one of steps 310-340 is performed on a virtual machine comprising a portion of a graphics processing unit.

In some examples, embodiments of the present disclosure improve MOE-LLMs 108 by using a restricted set of experts. For instance, embodiments of the present disclosure describe a process that preserves QoS-SLOs and maximizes compute throughput of the GPUs based on using domain-aware scheduling, pre-selecting domain-specific experts, switching domain experts, and/or offloading inactive experts. For instance, embodiments of the present disclosure may use domain-aware scheduling to schedule incoming requests in a domain-aware manner based on first sorting the requests. Once the domain of incoming requests is known (e.g., based on using the domain-aware scheduling), the relevant experts at each layer of the model are pre-selected to be used. Following, once a pool of requests is exhausted, a next set of domain-Substitute specific requests are scheduled and pre-selection of a potentially different set of experts is performed. Additionally, and/or alternatively, the inactive experts may be offloaded from the memory of the GPU. This and other embodiments are described in further detail above.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

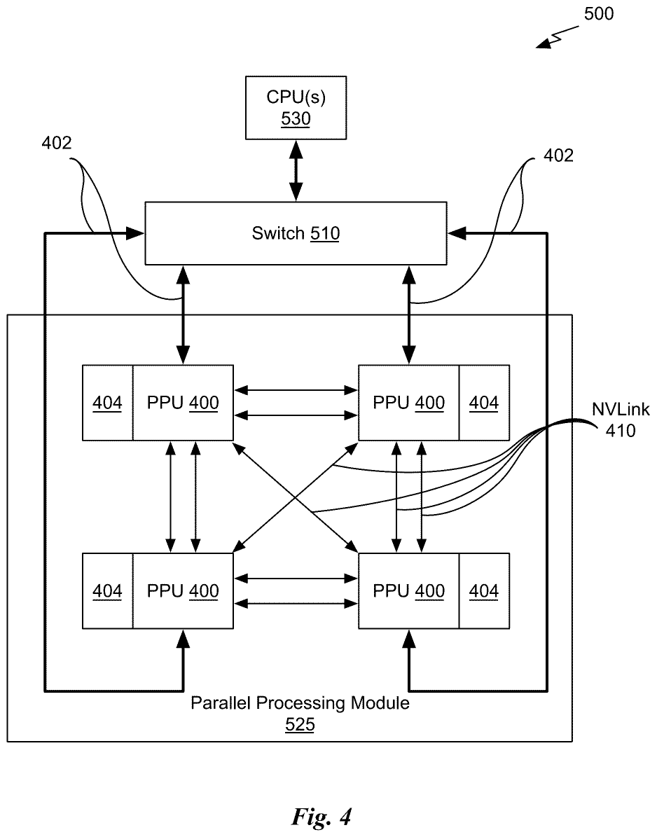

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

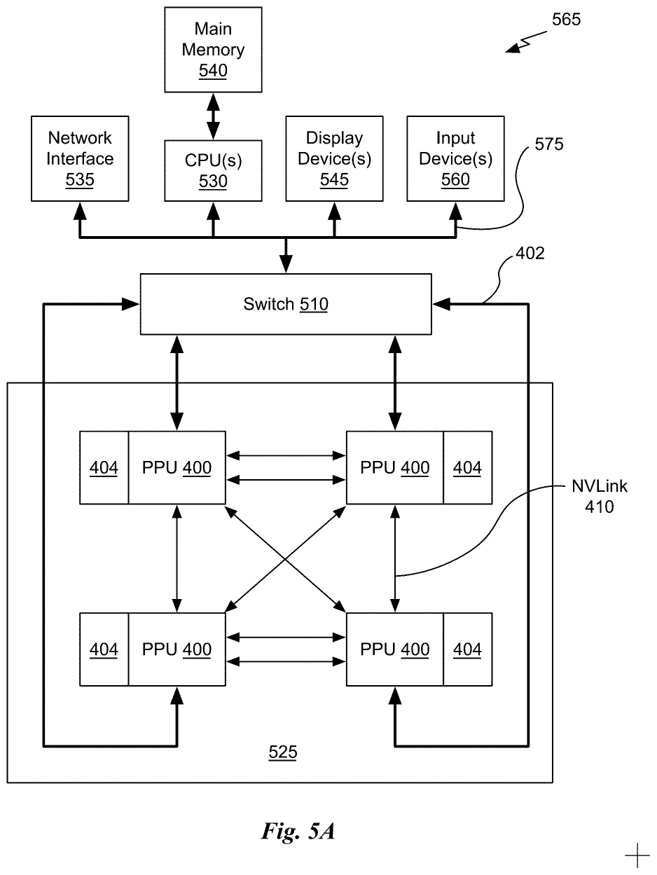

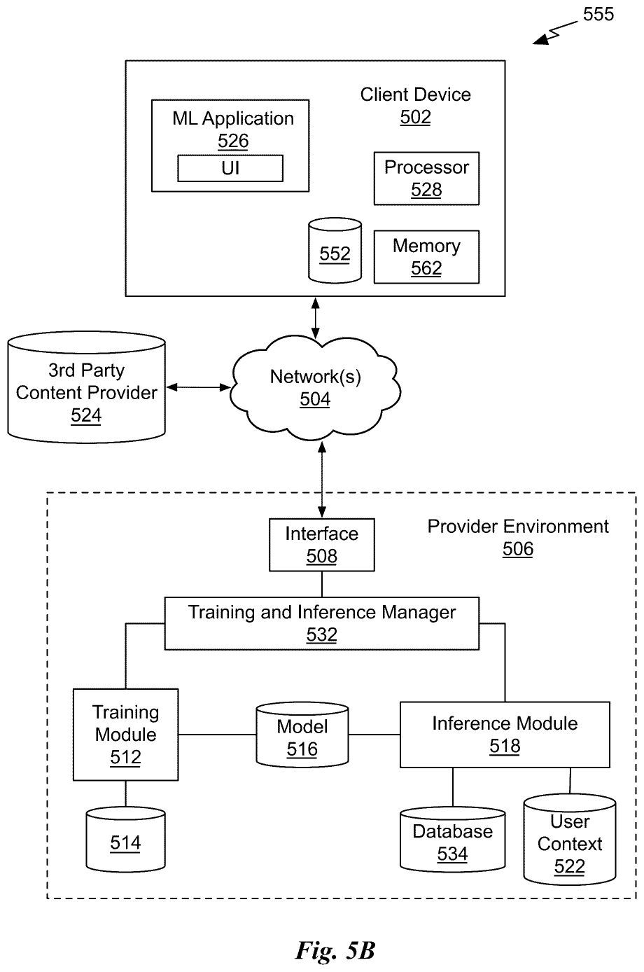

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system.

Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUS (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment-and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

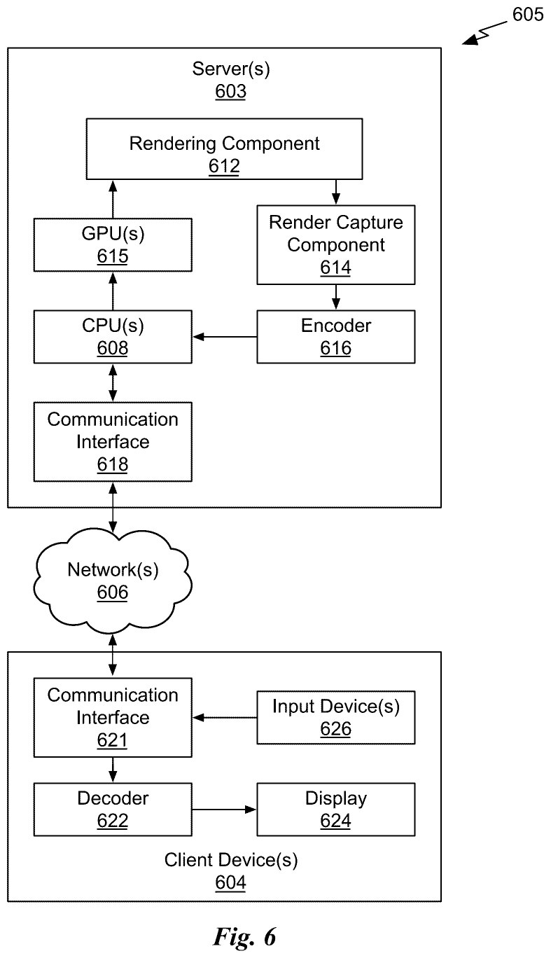

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering-in particular ray or path tracing for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for processing a pool of incoming requests using a mixture of expert large language model (MOE-LLM), comprising:
sorting the pool of incoming requests into a plurality of groups of requests based on using a scheduler that selects one or more subsets of a plurality of feedforward layers (FFNs) from the MOE-LLM to service the plurality of groups of requests;
loading a first subset of the one or more subsets of the plurality of FFNs into memory of a graphics processing unit (GPU) based on a first group of requests from the plurality of groups of requests; and
servicing the first group of requests using the first subset of the plurality of FFNs that are loaded into the memory of the GPU to generate responses to the first group of requests.

2. The computer-implemented method of claim 1, further comprising:
receiving the pool of incoming requests from a plurality of user devices; and
providing the generated responses to the first group of requests to one or more user devices from the plurality of user devices.

3. The computer-implemented method of claim 1, wherein sorting the pool of incoming requests comprises:
sorting a first request from the pool of incoming requests into the first group of requests based on the scheduler indicating that the first request is to be serviced using the first subset of the plurality of FFNs; and
sorting a second request from the pool of incoming requests into the first group of requests based on the scheduler indicating that the second request is to be also serviced using the first subset of the plurality of FFNs.

4. The computer-implemented method of claim 3, wherein the scheduler indicates that the first request and the second request are to be serviced using the first subset of the plurality of FFNs based on using cosine similarity or K-means clustering.

5. The computer-implemented method of claim 3, wherein the scheduler indicates that the first request and the second request are to be serviced using the first subset of the plurality of FFNs based on using a neural network, and wherein the computer-implemented method further comprises:
training the neural network prior to sorting the pool of incoming requests into the plurality of groups of requests.

6. The computer-implemented method of claim 1, further comprising:
while servicing the first group of requests, loading a second subset of the one or more subsets of the plurality of FFNs into the memory of the GPU based on a second group of requests from the plurality of groups of requests that are to be serviced after the first group of requests.

7. The computer-implemented method of claim 6, further comprising:
populating a queue for the plurality of groups of requests using a queuing algorithm, wherein the queue indicates that the first group of requests is to be serviced prior to the second group of requests being serviced, and
wherein loading the first subset of the plurality of FFNs and loading the second subset of the plurality of FFNs is based on the queue.

8. The computer-implemented method of claim 6, further comprising:
obtaining the MOE-LLM; and
storing the plurality of FFNs of the obtained MOE-LLM into memory of a central processing unit (CPU), and
wherein loading the first subset of the plurality of FFNs into the memory of the GPU comprises loading the first subset of the plurality of FFNs from the memory of the CPU into the memory of the GPU.

9. The computer-implemented method of claim 8, wherein loading the first subset of the plurality of FFNs from the memory of the CPU into the memory of the GPU comprises:
copying the first subset of the plurality of FFNs from the memory of the CPU; and
loading the copied first subset of the plurality of FFNs into the memory of the GPU.

10. The computer-implemented method of claim 8, wherein servicing the first group of requests comprises performing a plurality of iterations of using the first subset of the plurality of FFNs to generate the responses to the first group of requests, and
wherein the second subset of the plurality of FFNs are loaded into the memory of the GPU while the plurality of iterations is performed using the first subset of the plurality of FFNs.

11. The computer-implemented method of claim 8, further comprising:
servicing the second group of requests using the second subset of the plurality of FFNs to generate responses to the second group of requests; and
based on servicing the second group of requests, discarding the first subset of the plurality of FFNs from the memory of the GPU.

12. The computer-implemented method of claim 6, further comprising:
obtaining the MOE-LLM; and
storing the plurality of FFNs of the obtained MOE-LLM into memory of the GPU,
wherein loading the first subset of the plurality of FFNs into the memory of the GPU comprises selecting the first subset of the plurality of FFNs from the memory of the GPU to use for servicing the first group of requests, and wherein loading the second subset of the plurality of FFNs into the memory of the GPU comprises selecting the second subset of the plurality of FFNs from the memory of the GPU to use for servicing the second group of requests.

13. The computer-implemented method of claim 1, wherein the first group of requests indicate one or more additional FFNs to use to service the first group of requests, and wherein the first subset of the plurality of FFNs that are loaded into the memory of the GPU to service the first group of requests comprises one or more FFNs that are selected by the scheduler and at least one FFN from the one or more additional FFNs that are indicated by the first group of requests.

14. The computer-implemented method of claim 1, wherein at least one of the steps of sorting, loading, and servicing are performed on a server or in a data center to generate the responses, and the responses are streamed or provided to a user device.

15. The computer-implemented method of claim 1, wherein at least one of the steps of sorting, loading, and servicing are performed within a cloud computing environment.

16. The computer-implemented method of claim 1, wherein at least one of the steps of sorting, loading, and servicing are performed for training, testing, or certifying a neural network employed in a machine, robot, or autonomous vehicle.

17. The computer-implemented method of claim 1, wherein at least one of the steps of sorting, loading, and servicing is performed on a virtual machine comprising a portion of a graphics processing unit.

18. A system for processing a pool of incoming requests using a mixture of expert large language model (MOE-LLM), comprising:
one or more processors; and
a non-transitory computer-readable medium having processor-executable instructions stored thereon, wherein the processor-executable instructions, when executed by the one or more processors, facilitate:
sorting the pool of incoming requests into a plurality of groups of requests based on using a scheduler that selects one or more subsets of a plurality of feedforward layers (FFNs) from the MOE-LLM to service the plurality of groups of requests;
loading a first subset of the one or more subsets of the plurality of FFNs into memory of a graphics processing unit (GPU) based on a first group of requests from the plurality of groups of requests; and
servicing the first group of requests using the first subset of the plurality of FFNs that are loaded into the memory of the GPU to generate responses to the first group of requests.

19. The system of claim 18, wherein the processor-executable instructions, when executed by the one or more processors, further facilitate:
while servicing the first group of requests, loading a second subset of the one or more subsets of the plurality of FFNs into the memory of the GPU based on a second group of requests from the plurality of groups of requests that are to be serviced after the first group of requests.

20. A non-transitory computer-readable medium having processor-executable instructions stored thereon, wherein the processor-executable instructions, when executed, facilitate:
sorting a pool of incoming requests into a plurality of groups of requests based on using a scheduler that selects one or more subsets of a plurality of feedforward layers (FFNs) from a mixture of expert large language model (MOE-LLM) to service the plurality of groups of requests;
loading a first subset of the one or more subsets of the plurality of FFNs into memory of a graphics processing unit (GPU) based on a first group of requests from the plurality of groups of requests; and
servicing the first group of requests using the first subset of the plurality of FFNs that are loaded into the memory of the GPU to generate responses to the first group of requests.

21. The non-transitory computer-readable medium of claim 19, wherein the processor-executable instructions, when executed by the one or more processors, further facilitate:
while servicing the first group of requests, loading a second subset of the one or more subsets of the plurality of FFNs into the memory of the GPU based on a second group of requests from the plurality of groups of requests that are to be serviced after the first group of requests.
